(19) United States
(12) Patent Application Publication
(10) Pub. No.: US 2023/0162286 A1
(43) Pub. Date: May 25, 2023

(54) System, Method, and Platform for Providing Support and Financial Resources for Small Businesses

(71) Applicant: CommCap America, Inc., Cleveland, OH (US)

(72) Inventors: Kareem D. Lanier, Beachwood, OH (US); Nathaniel T. Bradley, Tucson, AZ (US)

(73) Assignee: CommCap America, Inc., Cleveland, OH (US)

(21) Appl. No.: 18/052,915

(22) Filed: Nov. 5, 2022

Related U.S. Application Data
(63) Continuation-in-part of application No. 16/412,094, filed on May 14, 2019.
(60) Provisional application No. 63/276,398, filed on Nov. 5, 2021.
(60) Provisional application No. 62/671,308, filed on May 14, 2018.

(51) Int. Cl. G06Q 40/06; G06Q 10/0639

(52) U.S. Cl. CPC G06Q 40/06; G06Q 10/06393

(57) ABSTRACT

A system, method, and platform for supporting small businesses through a platform. A business profile is generated for a business and connected to a platform. Business information is received from live and historical sources for the business profile. Performance of segments of the business are measured. Qualification criteria are determined for performance of the segments of the business. The performance of the segments of the business are rated utilizing the qualification criteria. Determining market opportunities for the business based on performance ratings for the business. Distributing resources to the business for acceptance in response to the market opportunities.

### PRIORITY STATEMENT

This application claims priority to U.S. Provisional Patent Application No. 63/276,398, filed on Nov. 5, 2021 and is a continuation-in-part of U.S. Non-Provisional patent application Ser. No. 16/412,094, filed on May 14, 2019 which claims priority to U.S. Provisional Patent Application No. 62/671,308 filed on May 14, 2018, which are hereby incorporated by reference in their entireties.

### BACKGROUND

### I. Field of the Disclosure

The illustrative embodiments relate to supporting small businesses. More specifically, but not exclusively, the illustrative embodiments relate to a system, method, apparatus, and platform for analyzing business information for a company to support readiness for growth and capital infusions.

### II. Description of the Art

Traditional government, incubator, financial, and business services and systems have not succeeded in sufficiently supporting small businesses including minority owned and at-risk businesses. As a result, these businesses have not grown or received resources at the same rate as other non-minority owned businesses. Minority owned business support individuals and areas that have been neglected, oppressed, or ignored. Supporting minority owned businesses is one of the best ways of growing the economy and providing jobs to all workers or potential workers. Existing services and systems for minority owned businesses have failed due to lack of innovation, automation, resource allocation, support services, and financial commitment. As a result, minority owned businesses have not prospered as they should have.

### SUMMARY OF THE DISCLOSURE

The illustrative embodiments provide a system, method, and platform for supporting small businesses through a platform. A business profile is generated for a business and connected to a platform. Business information is received from live and historical sources for the business profile. Performance of segments of the business are measured. Qualification criteria are determined for performance of the segments of the business. The performance of the segments of the business are rated utilizing the qualification criteria. Determining market opportunities for the business based on performance ratings for the business. Distributing resources to the business for acceptance in response to the market opportunities. In another embodiment, the system and platform include a processor and a memory storing a set of instructions. The set of instructions are executed by the processor to perform the method herein described. The businesses may include minority owned businesses

In other embodiments, the business profile may be registered with one or more devices, systems, or equipment in communication with the platform. Financing options may be presented to the business in response to the rating quotient. The business information may include business data associated with the business from multiple sources. The business may be a minority owned business or disadvantaged business. The market opportunities may include at least education/training, grants, debt, and equity opportunities. The business information qualification criteria, market opportunities, and resources may be presented, through a dashboard. The performance ratings may be gamified for multiple businesses including the business. The business may be listed on an exchange for investors to buy and trade stocks of the business. Suggestions for the business may be presented for the business to qualify for capital investment. Numerous grants may be applied for on behalf of the business.

The illustrative embodiments provide a system, method, and platform for compiling information for businesses supporting causes. Information is received from a business supporting one or more causes. The one or more causes supported by the business are verified. A determination is made whether the one or more causes are verified. Goods and services offered by the business are communicated in response to the one or more causes being verified. In another embodiment, the system and platform include a processor and a memory storing a set of instructions. The set of instructions are executed by the processor to perform the method herein described.

### BRIEF DESCRIPTION OF THE DRAWINGS

Illustrated embodiments are described in detail below with reference to the attached drawing figures, which are incorporated by reference herein, and where:

FIG. 1 is a pictorial representation of a system for managing cause-based purchases and services in accordance with an illustrative embodiment;

FIG. 2 further illustrates portions of the system of FIG. 1 in accordance with an illustrative embodiment;

FIG. 3 is a flowchart of a process for verifying causes supported by a business in accordance with an illustrative embodiment;

FIG. 4 is a flowchart of a process for communicating causes supported through purchases in accordance with an illustrative embodiment;

FIG. 5 is a flowchart of a process for tracking causes supported by a purchase in accordance with an illustrative embodiment;

FIG. 6 is a pictorial representation of a transaction summary in accordance with an illustrative embodiment;

FIG. 7 depicts a computing system in accordance with an illustrative embodiment;

FIG. 8 is a block diagram of a system for supporting minority owned businesses in accordance with an illustrative embodiment;

FIG. 9 is a flowchart of a process for supporting minority owned businesses in accordance with an illustrative embodiment;

FIGS. 10-11 are pictorial representations of a model of a system for supporting businesses in accordance with an illustrative embodiment;

FIG. 12 is a pictorial representation of a dashboard 1200 in accordance with an illustrative embodiment;

FIG. 13 is a pictorial representation of a platform cultivator 1300 in accordance with an illustrative embodiment;

FIG. 14 is a pictorial representation of a services cultivator 1400 in accordance with an illustrative embodiment;

FIG. 15 is a pictorial representation of an asset screening cultivator in accordance with an illustrative embodiment;

FIG. 16 is a pictorial representation of a business model cultivator 1600 in accordance with an illustrative embodiment;

FIG. 17 is a pictorial representation of a business plan cultivator 1700 in accordance with an illustrative embodiment;

FIG. 18 is a pictorial representation of a model scorecard 1800 in accordance with an illustrative embodiment.

### DETAILED DESCRIPTION OF THE DISCLOSURE

Small business makes up approximately 80% of all employment opportunities within the United States of America. Small businesses are one of the most important factors that determine the health and success of our local, state, regional, and national economies. The illustrative embodiments provide a system, method, platform, and devices that support minority and disadvantaged business owners in the United States through professional, legal, financial, supply-chain, investment, lending, exchange, educational, corporate finance, banking, franchise, philanthropic, business ratings, Scholastic, entertainment, athlete, human resources, and other resources, systems, services, and opportunities. The illustrative embodiments provide access to capital and resources for minority businesses that are significantly lower than white owned businesses. The illustrative embodiments streamline various costly yet highly important processes to provide access and passed to capital. As a result, it significantly reduces the high fixed costs associated with running a small business while allowing business owners to create, manage, and operate their business from any handheld mobile device.

Disparities in access to capital have been shown by the Brookings Institute which shows that most minority businesses are funded via personal income/savings, friends, and family with startup capital averaging approximately $35,000 per minority owned business while white owned businesses are similarly funded at approximately $135,000. In another example, African Americans own approximately 19 Community Banks while Caucasian Americans own approximately 5200 Community Banks showing significant disparities based on historic and deeply embedded racist beginnings of regulation, government oversight, and other measures. The illustrative embodiments help overcome systematic bias and, in some cases, outright to institutional racism, sexism, and discriminatory practices throughout the educational and entrepreneurial process that render minority owned businesses in constant disadvantage. Recent diversity and inclusion and environmental, social, and governance ratings, efforts, and indices have further illuminated glaring and stark realities that equality has not been achieved and diversity remains a paramount concern and challenge within the democratic and free enterprise system. Access to capital is among the primary reasons business operations do not stay financially afloat or achieve sustainability or growth. Investors that demand too much or pay day lenders may cripple entrepreneurial efforts of minority businesses. The illustrative embodiments provide a network and single technologic resource platform for minority owned businesses at all stages to capture the maximum number of services, education, opportunity, financial resources (e.g., launch, growth, maintain, etc.).

As described herein, causes may refer to support for minority owned businesses (e.g., race, sex, sexual orientation, geographic location, etc.), businesses with a majority of minority employees, contractors, and executives, and other historically neglected, oppressed, or ignored groups. In addition, businesses started by any individual(s), groups, organizations, or entities without significant resources or networks need additional support and services as described by the illustrative embodiments.

The current trends in consumer, corporate, foundation and family-based giving, and other forms of philanthropy have shifted towards crowd funding. This is especially true of cause-based shopping within the retail and consumer product goods sectors. Recent studies confirm that the vast majority of philanthropic giving around the world has shifted to crowd funding models and brands. For example, consumer products have begun to align with marketing that is utilized for social, medical, disease, biological, zoological, environmental, plant and habitat, disaster relief, and promotion of humane causes. The results of these efforts are often measured by the compound and rolling social impact model that is being directly integrated in the marketing of brands in business. In many cases, there are brands that have philanthropy built into their business model, however, the challenge lies in the lack of the ability for consumers to find these brands easily and verifying the giving and the true impact of these brands as true and accurate. The problem is compounded by the fact that smaller organizations have diverted funds from marketing because a larger portion of their profits are used to give back and/or support their cause-based programs. On a worldwide basis, brands and organizations are making changes to have an impact on the world with, in some cases, proceeds from each purchase of products, goods, and services that they provide.

The illustrative embodiments provide a system, method, and platform for distributing information and access to businesses that verifiably support worthwhile and charitable causes and initiatives. In one embodiment, a platform receives information for numerous businesses that purport to support worthwhile and charitable causes, actions, programs, and initiatives. The platform verifies the causes supported by the businesses by determining whether donations, time, and support are provided by the businesses as asserted. Any number of electronic and user resources and efforts may be utilized to verify the businesses support of their purported causes. If the verification is successful, the platform adds the businesses as an authorized or certified business (e.g., Xenia certified). As a result, the businesses are added to the platform as a verified partner with applicable information associated with the businesses and supported causes uploaded and displayed by the platform.

One embodiment provides a networked system, method, and apparatus for the automation of philanthropy, consumer giving, and cause pooling with a management capability that allows for the verification and ranking of organizational giving. The illustrative embodiments provide for a marketplace that provides access to all of the brands, services and organizations, small and large, on an internet connected philanthropy platform in which consumers may experience a one-stop shopping experience for all the businesses, brand, and products that currently have a social impact model offering built into the purchase, rebate, or giving program related to their product/services. In the past, philanthropy has been largely reserved for the rich and wealthy organizations. The illustrative embodiments provide for leveling of the playing field and the creation of crowd funding and scalable disaster relief and other means of consolidating the cause-based giving, while validating and verifying the amounts and true impacts related to giving.

One embodiment provides a system, method, device, mobile application and computer program for users to find, interact with, and purchase from brands who have a validated and verified social impact. The online and/or internet connected platform, as well as the brick and mortar stores carry rights to resell products and services from businesses that have a tangible social impact model built into their business.

Another embodiment provides a way for businesses that have a social impact model to be represented on the ecommerce platform and/or the brick and mortar store, while either maintaining their own website or using the system, method, device, mobile application, and computer programs available to market, host, and sell the products and services these businesses are selling directly or indirectly (or to enhance their efforts).

Another embodiment provides a system, method, device, mobile application, and computer program for a consumer to search and filter products and services in any manner, such as for meaningful shopping and acquisition of goods and services. The consumer may search and filter information and data utilizing any portion of the system, method, device, mobile application, and computer program in order to shop by a specified cause. The consumer may also search, and filter results based on cause, region of the world, celebrity endorsements, best rating, corporate/organization principals, highest impact, and so forth.

Another embodiment provides a resource for the consumer to view, at a glance, a score card of the validity of the business model of each brand that is represented. Each of the businesses, organizations, or individuals represented in the platform may have a summary of who they are, and the causes, principles, donations, or actions supported or provided.

Another embodiment provides a running tally of every single impact each consumer has had on the world in a live ticker, pop up, summary, messages, or similar formula displayed with infographics, detailing the total number and types of causes supported based on applicable purchases.

Another embodiment provides a checkout system that provides the most secure check out possible, collecting the least information possible in order to fulfill the order in a timely matter and accepting any form of payment currently acknowledged by a FDIC insured bank including but not limited to, bitcoin, credit card, PayPal®, Dwolla®, Amazon Pay®, Venmo®, Zelle®, direct deposit, electronic checks, and Apple Pay®. Another embodiment provides a receipt upon a completed purchase to be sent to the consumer both electronically and physically that details each social impact that they purchased through that singular purchase.

Another embodiment provides specific cause-based marketing. Once a user has searched, browsed, or purchased a good or service connected with a specific cause, the platform will immediately rework the way the goods are presented on the landing page and all personalized marketing campaigns to include and/or focus on the singular cause that the consumer had originally interacted with or sought out.

Another embodiment is a rating practice in which the customers may not only rate and review the products and services, but also the businesses, organizations, entities, or individuals (collectively businesses) they have decided to purchase from. In turn, the businesses have a portion of the platform designated to sharing the impact that they have had on society due strictly to the purchases made through the platform, system, method, device, mobile application, and computer program mentioned previously.

Another embodiment is to provide a virtual and/or internet connected experience to the consumer through, including, but not limited to, their computer, handheld device, wearable technology, and or internet connected device in which the consumer may outfit themselves and/or a room in their house with the goods selected in order to specifically see the impact all of their purchases an outfit or house decor/redesign may have.

Another embodiment is to provide a brick and mortar store in which, upon entering, the retail store and retail store personnel are directly informed of causes that the consumer is passionate about and has shopped for or sought out before, in order to lead them to, suggest, and market to them specific products based on their prior purchases.

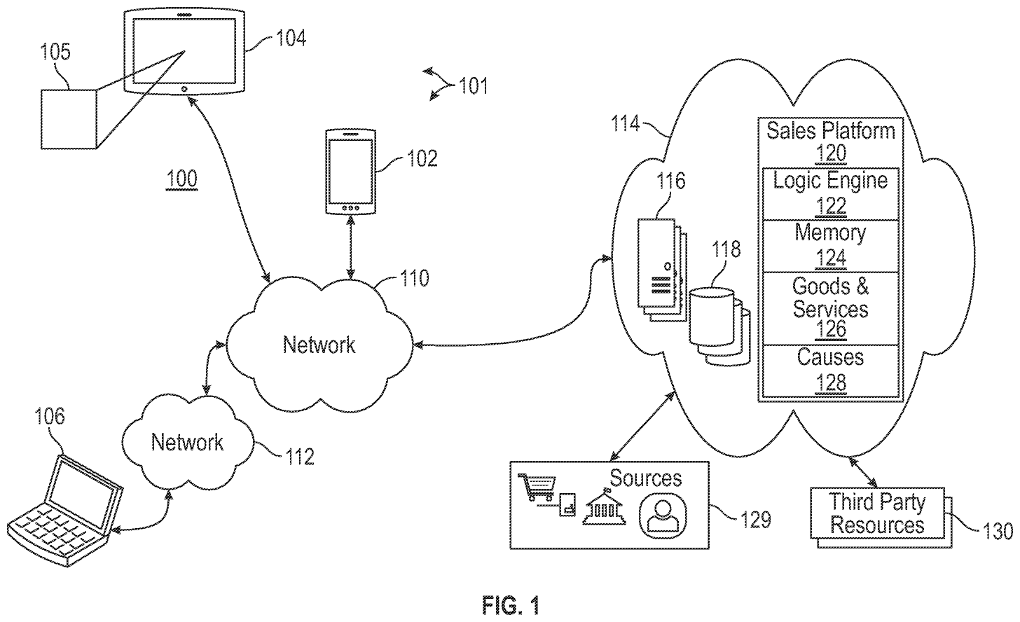

FIG. 1 is a pictorial representation of a system 100 for managing cause-based purchases and services in accordance with an illustrative embodiment. In one embodiment, the system 100 of FIG. 1 may include any number of devices 101, networks, components, software, hardware, and so forth. In one example, the system 100 may include a smart phone 102, a tablet 104 displaying a graphical user interface 105, a laptop 106 (altogether devices 101), a network 110, a network 112, a cloud system 114, servers 116, databases 118, a sales platform 120 including at least a logic engine 122 and a memory 124. The cloud system 114 may further communicate with sources 129 and third-party resources 130.

Each of the devices, systems, and equipment of the system 100 may include any number of computing and telecommunications components, devices or elements which may include processors, memories, caches, busses, motherboards, chips, traces, wires, pins, circuits, ports, interfaces, cards, converters, adapters, connections, transceivers, displays, antennas, operating systems, kernels, modules, scripts, firmware, sets of instructions, and other similar components and software that are not described herein for purposes of simplicity.

In one embodiment, the system 100 may be utilized by any number of users, organizations, or providers to aggregate, manage, review, analyze, process, advertise, market, display, and/or distribute products and services as well as the causes supported by the products and services. In one embodiment, the goods and services represent any number of items, content, products, goods, or services sold by a business, entity, organization, or entity. In one embodiment, the system 100 may utilize any number of secure identifiers (e.g., passwords, pin numbers, certificates, etc.), secure channels, connections, or links, virtual private networks, biometrics, or so forth to upload, manage, and secure the goods and services and process applicable transactions. The devices 101 are representative of multiple devices that may be utilized by businesses or consumers, including consumer, network, and business devices and associated operating systems, programs, sets of instruction, scripts, kernels, and other software, and may also include devices integrated with or utilized by the cloud system 114. The devices 101 utilize any number of applications, browsers, gateways, bridges, or interfaces to communicate with the cloud system 114, platform 120, and/or associated components.

The wireless device 102, tablet 104, and laptop 106 are examples of common devices that may be utilized to manage available goods and services or perform transactions related thereto. Other examples of devices 101 may include e-readers, cameras, video cameras, audio systems, gaming devices, vehicle systems, art systems, kiosks, point of sale systems, televisions, smart displays, monitors, entertainment devices, medical devices, virtual reality/augmented reality systems, or so forth. The devices 101 may communicate wirelessly or through any number of fixed/hardwired connections, networks, signals, protocols, formats, or so forth. In one embodiment, the smart phone 102 is a cell phone that communicates with the network 110 through a 5G connection. The laptop 106 may communicate with the network 112 through an Ethernet, cellular, or Wi-Fi connection.

The cloud system 114 may aggregate, manage, analyze, and process content and user requests across the Internet and any number of networks, sources 129, and third-party resources 130. For example, the networks 110, 112, 114 may represent any number of public, private, virtual, specialty, or other network types or configurations. The different components of the system 100, including the devices 101 may be configured to communicate using wireless communications, such as Bluetooth, Wi-Fi, or so forth. Alternatively, the devices 101 may communicate utilizing satellite connections, Wi-Fi, 3G, 4G, 5G, LTE, personal communications systems, DMA wireless networks, and/or hardwired connections, such as fiber optics, T1, cable, DSL, high speed trunks, powerline communications, and telephone lines. Any number of communications architectures including client-server, network rings, peer-to-peer, n-tier, application server, mesh networks, fog networks, or other distributed or network system architectures may be utilized. The networks 110, 112, 114 of the system 100 may represent a single communication service provider or multiple communications services providers.

The sources 129 may represent any number of web servers, distribution services (e.g., text, email, video, etc.), media servers, platforms, distribution devices, or so forth. In one embodiment, the sources 129 may represent the businesses that sell and make available goods and services utilizing the system 100. The cloud system 114 (or alternatively the cloud network) including the sales platform 120 is specially configured to perform the illustrative embodiments.

The sources 129 may also represent social media networks and services or social media may be accessed utilizing applications, browsers, or software on the devices 101. The users may share one or more of sellers, goods and services, associated causes, and messages, thought, and content regarding any of the above. As a result, positive or negative information may be utilized to influence other potential purchasers. In particular, users that support the same causes and have similar needs/wants for goods and services may be able to make concerted efforts. For example, a user may share on social media that carpet cleaning services offered at a discount support a local art group while encouraging people to use their services. Positive peer pressure may be utilized to support different efforts.

The cloud system 114 or network represents a cloud computing environment and network utilized to aggregate, process, manage, sell, and distribute content and support the associated causes. The cloud system 114 allows goods and services from multiple businesses, users, managers, or service providers to be centralized. In addition, the cloud system 114 may remotely manage configuration, software, and computation resources for the devices of the system 100, such as devices 101. The cloud system 114 may prevent unauthorized access to data, tools, and resources stored in the servers 116, databases 118, and well as any number of associated secured connections, virtual resources, modules, applications, components, devices, or so forth. In addition, a business may more quickly upload, aggregate, process, manage, and distribute goods and services, where authorized, utilizing the cloud resources of the cloud system 114 and sales platform 120. In addition, the cloud system 114 facilitates distribution of cause information and dated associated with the business. The cloud system 114 allows the overall system 100 to be scalable for quickly adding and removing businesses, users, authorized sellers, cause-based information, analysis modules, moderators, programs, scripts, filters, transaction processes, distribution partners, or other users, devices, processes, or resources. Communications with the cloud system 114 may utilize encryption, secure tunnels, handshakes, secure identifiers (e.g., passwords, pins, keys, scripts, biometrics, etc.), firewalls, specialized software modules, or other data security systems and methodologies as are known in the art.

Although not shown, the cloud system 114 may include any number of load balancers. The load balancer is one or more devices configured to distribute the workload of processing the uploaded goods and services as well as applicable transactions to optimize resource utilization, throughput, and minimize response time and overload. For example, the load balancer may represent a multilayer switch, database load balancer, or a domain name system server. The load balancer may facilitate communications and functionality (e.g. database queries, read requests, write requests, command communications, stream processing, etc.) between the devices 101 and the cloud system 114. For example, the cloud system 114 may offload verification information for new businesses that seek to be added to the system 100 along with applicable goods and services information. Load balancing may be performed between automatic systems and devices as well as individual users. Other intelligent network devices may also be utilized within the cloud system 114.

The servers 116 and databases 118 may represent a portion of the sales platform 120. In one embodiment, the servers 116 may include a web server 117 utilized to provide a website and user interface (e.g., user interface 107) for interfacing with numerous users. Information received by the web server 117 may be managed by the sales platform 120 managing the servers 116 and associated databases 118. For example, the web server 117 may communicate with the database 118 to respond to read and write requests. The databases 118 may utilize any number of database architectures and database management systems (DBMS) as are known in the art. The databases 118 may store the content associated with each consumer/purchaser/user which may specify an address, name, age, biometric identifiers, payment information, location, cause preferences, cause restrictions, and so forth. The database 118 may also store information relating to sellers including products/items/services, causes supported, charitable information (e.g., contribution information, percentages, details, etc.), and so forth. Any number of secure identifiers, such as inaudible tones, QR codes, serial numbers, or so forth may be utilized to ensure that content, personal, or transaction information is not improperly shared or accessed.

In one embodiment, the user interface 105 is a portion of a sales application (not shown) executed by the devices 101. For example, the user interface 105 may represent the portion of the sales platform visible to the user for communicating and receiving information, data, and content. The user interface 105 may be made available through the various devices 101 of the system 100. In one embodiment, the user interface 105 represents a graphical user interface, audio interface, or other interface that may be utilized to communicate, display, receive, and otherwise manage data and information. For example, the user may navigate products and services that support causes and interests associated with the user utilizing the user interface 105. The user interface 105 may utilizer any number of windows, icons, drop-down menus, graphics, images, and content. The graphical user interface 105 may be presented based on execution of one or more applications, browsers, kernels, modules, scripts, operating systems, or specialized software that is executed by one of the respective devices 101. The user interface may display current and historical data as well as trends. The user interface 105 may be utilized to set the user preferences, parameters, and configurations of the devices 101 as well as upload and manage the content sent to the cloud system 114.

In one embodiment, the system 100 or the cloud system 114 may also include the sales platform 120 which is one or more devices utilized to enable, initiate, aggregate, analyze, process, and manage goods, services, causes, and so forth with one or more communications or computing devices. The sales platform 120 may include one or more devices networked to manage the cloud network and system 114. For example, the sales platform 120 may include any number of servers, routers, switches, or advanced intelligent network devices. For example, the sales platform 120 may represent one or more web servers that performs the processes and methods herein described.

In one embodiment, the logic engine 122 is the logic that controls various algorithms, programs, hardware, and software that interact to receive, aggregate, analyze, rank, process, score, communicate, and distribute goods and services, content, alerts, reports, messages, or so forth. The logic engine 122 may utilize any number of thresholds, parameters, criteria, algorithms, instructions, or feedback to interact with users and interested parties and to perform other automated processes. The logic engine 122 may represent a processor. The processor is circuitry or logic enabled to control execution of a program, application, operating system, macro, kernel, or other set of instructions. The processor may be one or more microprocessors, digital signal processors, application-specific integrated circuits (ASIC), central processing units, or other devices suitable for controlling an electronic device including one or more hardware and software elements, executing software, instructions, programs, and applications, converting and processing signals and information, and performing other related tasks. The processor may be a single chip or integrated with other computing or communications elements.

The memory 124 is a hardware element, device, or recording media configured to store data for subsequent retrieval or access at a later time. The memory 124 may be static or dynamic memory. The memory 124 may include a hard disk, random access memory, cache, removable media drive, mass storage, or configuration suitable as storage for data, instructions, and information. In one embodiment, the memory 124 and logic engine 122 may be integrated. The memory 124 may use any type of volatile or non-volatile storage techniques and mediums.

In one embodiment, cloud system 114 or the sales platform 120 may coordinate the methods and processes described herein as well as software synchronization, communication, and processes. The third-party resources 130 may represent any number of human or electronic resources utilized by the cloud system 114 including, but not limited to, businesses, entities, organizations, individuals, government databases, private databases, web servers, research services, service providers, and so forth. For example, verification of charitable giving (e.g., time, resources, money, etc.) may be verified through any number of auditing groups, charitable organizations, watchdog groups, or so forth.

In one embodiment, the sales platform 120 may implement a blockchain ledger, manager, or technology. In another embodiment, the blockchain ledger may be accessible through sources 129. Any number of existing blockchain companies or providers may be utilized (Aeternity, Ethereum, Bitcoin, Dfinity, ContentKid, Blockphase, Chain of Things, Flowchain, Decissio, Cognate, SkyHive, Safe, etc.).

The blockchain 126 is utilized as a way to store and communicate goods and services along with supported causes. The blockchain 126 may utilized one or more distinct ledgers for different entities, services providers, types of products, users, or so forth. For example, each new seller (or product, good, or service) received by the sales platform 120 is assigned a secure identifier. In one embodiment, the secure identifier is an inaudible tone or other key that may be integrated into a product listing, profile, or other information for securing and authenticating the sellers, goods/services, supported causes, and so forth. The blockchain 126 may cross-reference updates to the content with the original record for the content to ensure proper licensing, management, and transactions. In one example, different licensing tiers, pricing algorithms, license verification, inaudible tone verification, cause information, and payments are combined to create a unique platform. The illustrative embodiments provide a system 100, cloud system 114, and sales platform 120 for compiling businesses that support causes and documenting consumer transactions that support those causes.

The blockchain may also utilize any number of payment systems (e.g., PayPal®, Venmo®, Dwolla®, wire transfers, credit cards, Quicken®, etc.) to receive money and distribute payments. In one embodiment, the sales platform 120 may receive a small fee or percentage per transaction, purchased item, browsing session, or so forth.

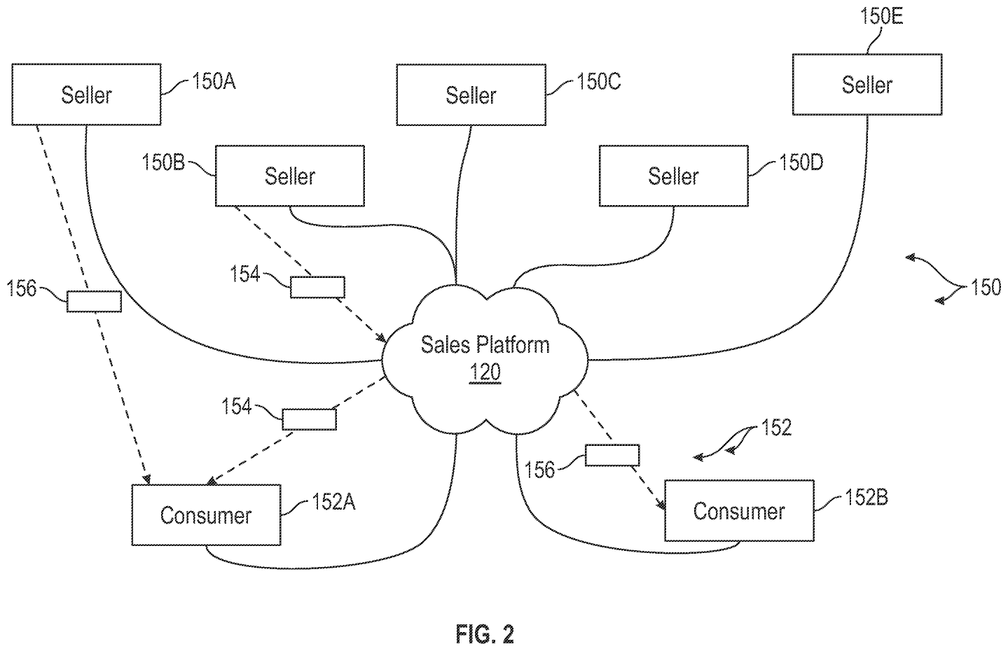

In one embodiment, the sales platform 120 may be utilized to verify sellers and associated goods and services 126 and causes 128 associated with the goods and services 126. The sales platform 120 may utilize an application or application eco system utilized by the devices 101 to automatically determine and retrieve applicable data, information, and content associated with the sellers, goods and services 126, and causes 128. In one embodiment, an initial account setup process may be utilized by the users and sellers. Thereafter, information may be automatically retrieved from systems, devices, accounts, services, programs, operating systems or other hardware or software devices or interfaces utilized by the users or sellers (see the devices of FIGS. 1 and 2).

The third-party resources 130 may represent any number of electronic or other resources that may be accessed to perform the processes herein described. For example, the third-party resources 130 may represent government, private, and charitable servers, databases, websites, services, and so forth for verifying charitable contributions. In another example, auditors may verify information provided by businesses with regard to the causes 128 associated with the businesses themselves or their associated goods and services 126.

In one embodiment, the sales platform 120 may distribute electronic (e.g., in-application messages, email messages, text messages, etc.) and/or print notifications and messages to the user and sellers. For example, sellers may be notified if and when their products and services are certified by the sales platform 120 for platform inclusion, sales, and marketing. The sellers may also be notified when additional information, data, or details are required to verify the causes they acknowledge supporting.

FIG. 2 further illustrates portions of the system 100 of FIG. 1 in accordance with an illustrative embodiment. As shown the sellers 150A-E (jointly sellers 150) may represent the sources 129 of FIG. 1. The sellers 150 may represent any number of businesses, retailers, service providers, individuals, organizations, entities, or so forth referred to as sellers 150 or businesses for purposes of simplicity. The consumers 152A, 152B (jointly consumers 152) represent any number of buyers, users, consumers, groups, or individuals that purchase goods and services from the sellers 150 as performed through or enabled by the sales platform 114. In one embodiment, the sales platform 114 may represent all or portions of the system 100 of FIG. 1 (including the cloud system 114, servers 116, databases 118). The sellers 150 may submit goods, services, products, and cause information that is aggregated, stored, and verified by the sales platform 120. As previously noted, the sales platform 120 may also represent one or more manufacturing or distribution centers, systems, devices, facilities, or so forth. The sellers 150 and consumers 152 may represent any number of individuals or groups (e.g., hundreds, thousands, millions, etc.).

As noted, the sellers 150 may send or distribute goods and services 154 through distribution systems (e.g., delivery networks, brick and mortar stores, etc.), the cloud system 114, or directly to the consumers 152. In one embodiment, the seller 150B may distribute goods and services 154 to the consumer 152A through the sales platform 120. The sales platform 120 may perform distribution of the goods and services 154. For example, the sales platform 120 may include any number of physical storage, digital storage, warehousing, and distribution systems, facilities, professionals, employees, contractors, electronics, and so forth.

In another embodiment, the seller 150A may provide information to the consumer 152A through the sales platform, but distribution of goods and services 156 may occur directly between the seller 150A and the consumer 152A. As a result, the sales platform 120 may facilitate the advertising, marketing, information distribution and retrieval, and sales process without performing distribution. For example, the sales platform 120 may track or monitor referrals or transactions that are enabled by the sales platform 120 to receive a referral fee, payment percentages, royalties/licenses, transaction fees, or other agreed upon payments. Distribution of the goods and services 156 may also be performed from or through the sales platform 120, such as delivery of goods and services 156 from the seller 150B to the sales platform 120 and then from the sales platform 120 to the consumer 152B.

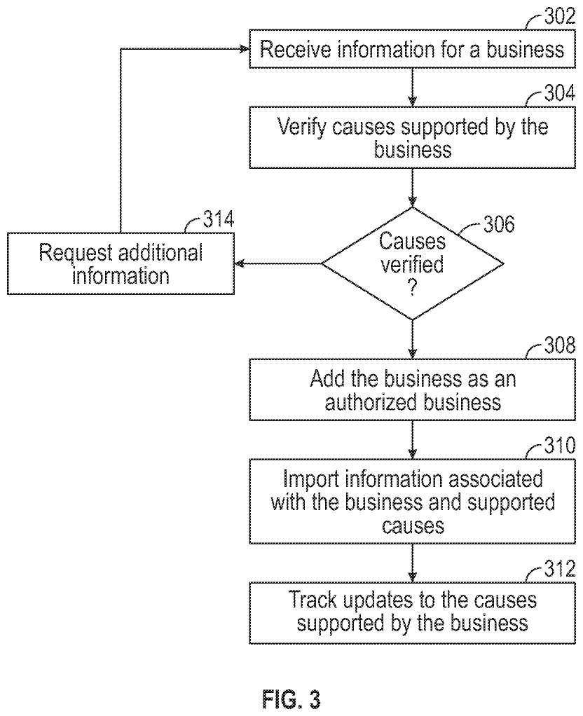

FIG. 3 is a flowchart of a process for verifying causes supported by a business in accordance with an illustrative embodiment. The process of FIGS. 3-5 may be performed by a platform, device, server, or other equipment in accordance with illustrative embodiments (referenced as a platform). All or portions of the process of FIG. 3 may be performed automatically. In one embodiment, the process may begin by receiving information for a business (step 302). The business may represent any number of corporations, entities, individuals, groups, or collaborations (of any size) that may sell goods or services. The business may submit an application, form, disclosure, request, or other data and information to the platform. The application may require vetting or authorization before the business is authorized. The platform may alternatively seek out businesses or information utilizing web crawlers, searching algorithms, data analytics, and so forth. In another embodiment, users may retrieve information applicable to the business from any number of electronics or physical sources, such as websites, advertisements, marketing brochures, e-brochures, pamphlets, word-of-mouth, reviews, user references, recommendation sites, and so forth.

Next, the platform verifies causes supported by the business (step 304). The verification may be performed utilizing electronic and physical resources. For example, the platform may automatically search databases, records, statements, and other applicable data and information that verifies money, effort, hours, and other material contributions or support from the business to the specified cause(s). The applicable information may also be gathered together as a resource for a user or administrator responsible for performing ultimate verification. In one embodiment, the platform may send one or more messages (e.g., emails, in-application messages, phone calls, texts, written requests, etc.) to verify that the causes are supported. For example, email messages may be sent to email addresses on record for the charitable cause. The message may specify the contribution that the business has purportedly made with ayes or no verification available. In some embodiments, multiple verifications may need to be performed for different products/services, charitable organizations/causes/interests, contribution levels, and so forth. Verification efforts may be supplemented by human interactions, input, intelligence, or verification as required.

Next, the platform determines whether the causes are verified (step 306). The verification may be determined utilizing all of the data and information previously noted. In one example, verification of all or a majority of the causes associated with the business may ensure that the business is able to participate as an authorized business on the platform. In another example, if donations of money purported to be made by the businesses cannot be verified, the cause is not verified in step 306. For example, a rejection communication may be sent to the business or a request for additional information as is described below.

In one embodiment, the platform may utilize machine learning to verify transactions verified. For example, the logic of the platform may determine the systems utilized by the applicable cause to document verifications. The logic may then begin by first automatically determining whether the cause is verified by determining applicable information, such as non-profit filings, donation statements, listed partners, rankings by applicable groups, and so forth.

Next, the platform adds the business as an authorized business (step 308). In one embodiment, the authorized business may be assigned a number, verification code, or other relevant information. The authorized business may also be given permission to indicate a certification (e.g., Xenia Certified, Doing Good Verified, etc.). Any number of proprietary or protected logos marks, pins, digital certificates, passwords, encryption schemes, or other digital authentications may be utilized.

Next, the platform imports information associated with the business and supported causes (step 310). In one embodiment, the platform may present an interface for the business to provide specific information. For example, the information may specify the amount and types of contributions (e.g., money, time/hours, services, in-kind contributions, etc.), actions, taken, dates, recipients, transaction information, tax information, and causes supported. Specific products, services, or purchase amounts may be associated with detailed information regarding donations, hours served, and so forth. The platform may also import accounting, statistical, audited information, or other data about the business and supported causes. The platform or platform service provider may provide application program interfaces, programs, scripts, or tools for automatically sending and receiving the needed information. As a result, even if some of the applicable information is manually entered by the business, the platform may be able to automatically receive or import the information.

Next, the platform tracks updates to the causes supported by the business (step 312). As noted, the businesses may be provided a designated website, program, application program interface, script, interface, username and password, access point, or other system or process for providing updated information. Updates are used to add new products, services, causes, charitable contribution amounts, and so forth. The updates may be received over hours, days, weeks, months, or years.

If the causes are not verified for the business during step 306, the platform requests additional information (step 314). The additional information may be utilized to further vet the business before it can be added to the platform. During step 314, a message or communication may be sent to the business indicating that the causes associated with the business have not been verified, rejected, or require additional information.

The process of FIG. 3 ensures that businesses are fully vetted to ensure that they do contribute as advertised. Verification provides users of the platform increased assurances and confidence in their financial purchases or investments through the platform. The processes and steps of FIGS. 3-5 may be combined, interchanged, or performed sequentially, concurrently, or simultaneously.

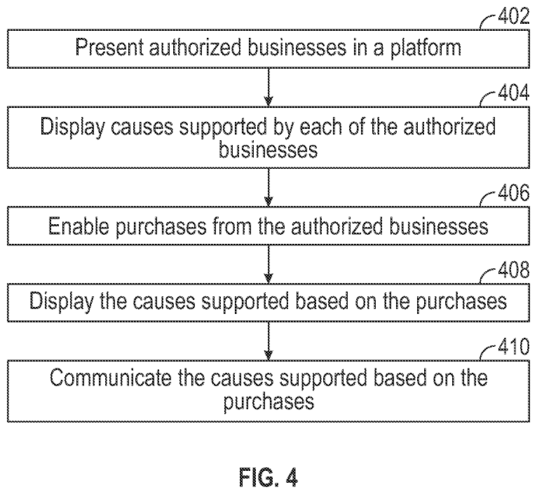

FIG. 4 is a flowchart of a process for communicating causes supported through purchases in accordance with an illustrative embodiment. In one embodiment, the process of FIG. 4 may begin by presenting authorized businesses utilizing a platform (step 402). The businesses may be presented utilizing the platform. The platform may represent or be utilized by one or more websites, mobile applications, programs, emails, advertisements, or so forth. The authorized businesses may all have been vetted, verified, and otherwise authorized to utilize the platform (i.e., using the process of FIG. 3).

In one embodiment, the products and services associated with each business may also be displayed in step 402. For example, common products and services may include clothes, shoes, electronics, vehicles, food, professional services (e.g., accounting services, medical/healthcare services, legal services, management services, financial services, insurance services, engineering services, etc.), cleaning services, medical device, pharmaceuticals, logistics/transportation, construction, real estate, vehicles, information technology services, industrial services, food services, travel services, and so forth. The platform may display products and services that may be directly purchased or may link to resources where they may be purchased. Any number of specialized links, codes, digital certificates, cookies, or other information may be utilized to track consumption and utilization of the content, information, and data associated with the authorized business presented by the platform.

Next, the platform displays causes supported by each of the authorized businesses (step 404). The causes may generally be associated with one or more businesses. For example, charitable organizations associated with a shoe company may be listed. Additionally, the amounts and types of support provided by the businesses may be communicated. For example, a shoe company may indicate that for every shoe that is bought one is donated to a child in poverty in a specified geographic. Actions, donation amounts, donation types, services rendered, regions benefited, and other details regarding the causes supported by each of the authorized businesses and their associated products/services. The information may be presented visually/graphically, audibly, using video, or any combination thereof.

Next, the platform enables purchases from the authorized businesses (step 406). The platform may enable direct transactions or indirect transactions utilizing links, pop-ups, or so forth. In addition, any number of websites, distributors, wholesalers, or third-parties may be utilized. In one embodiment, the platform may provide a dedicated website, mobile application, and computer program that may be utilized to search, filter, and navigate the authorized businesses, associated goods and services, and applicable causes. In one embodiment, money, currency, tokens, or other renumeration may be accepted directly by the platform and distributed to the business, causes, or other applicable parties by the platform. In another embodiment, the individual business may accept payments and support their cause(s) as advertised to consumers. In one embodiment, the platform may operate as a non-profit or charitable institution itself. In another embodiment, the platform may accept small payments or referral/affiliate payments for the resources, network, platform, and services provided.

Next, the platform displays the causes supported based on the purchases (step 408). Step 408 indicates the amount, type, level, support, and other cause information that is provided in response to the user's purchase. As noted, the causes supported may vary by specific product and service purchased. Thus, the information and data specific to the transaction may be communicated to the user.

Next, the platform communicates the causes supported based on the purchases (step 410). In one embodiment, a receipt is sent for the transaction indicating the product/services ordered, amounts, price, and the causes supported based on the transaction. The information, data, and transaction details including the causes supported may be sent in any number of formats. In one example, an email, text, or in-application message may be communicated to the user to reduce physical resources utilized. In another example, a printing and shipping service may receive a file or document with the relevant information before printing and shipping the document.

The causes supported by the user may also be display per category, time period, or other relevant information. Different types of selections or filtering may be applied. In one example, the user may be able to see the causes and details of support for those causes that were provided through their purchases for the current year or in the last twelve months. The information may even specify a portion of the transaction that is tax deductible or considered a charitable gift as allowed by applicable laws.

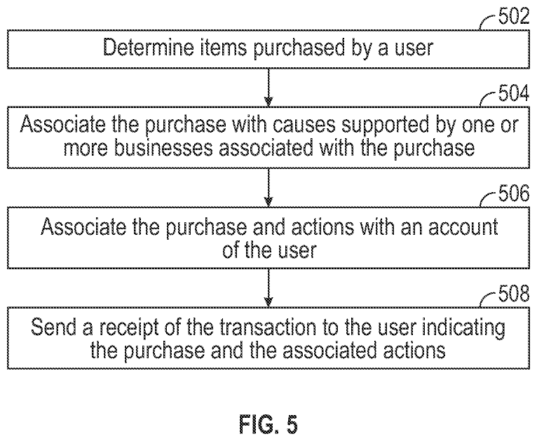

FIG. 5 is a flowchart of a process for tracking causes supported by a purchase in accordance with an illustrative embodiment. The process beings by determining items purchased by a user (step 502). The purchased items may represent products or services as previously noted. The items may be tracked utilizing carts, databases, discreet messages, cookies, messages, identifiers, tracking information, or so forth. In one embodiment, the platform tracks items purchased by numerous users across multiple businesses associated with the platform.

Next, the platform associates the purchases with causes supported by one or more businesses associated with the purchase (step 504). The causes and actions may represent charitable, environmental, monetary, service, or other activities supported by the business associated with the purchased goods or services. Different items from a single business may have different actions associated with their purchase. For example, food purchases may support feeding hungry children locally whereas clothing purchases may support individuals that suffer from domestic abuse. Some examples of common charitable causes and activities may include disease/treatment and prevention, medical services, addressing homelessness, mental illness, job/employment/education, vaccinations, literacy initiatives, food and water distribution, affordable housing, animal/pet services and protection, environment/conservation, arts/cultures/humanities, churches, disaster relief, peace and human rights, child sponsorship, scholarships, performing arts, historical societies, public broadcast and media, reform initiatives, and other applicable charities.

Next, the platform associates the purchase and supported causes with an account of the user (step 506). The user is credit for performing or assisting the cause in response to their purchase of the items. In some jurisdictions or countries, the user may be able to claim a tax credit, subsidiary, or benefit for their purchase of the times. As a result, the platform tracks the purchases made by each user through the platform. Users may also receive plaques, certificates, awards, or other recognition for significantly supporting one or more causes.

Next, the platform sends a receipt of the transaction to the user indicating the purchase and the associated actions (step 508). As noted, the receipt may be sent electronically (e.g., email, text, in-app message, etc.) or in physical format. The receipt may also be displayed at the user's request or automatically in response to the user accessing the platform. For example, a “Causes Supported” indicator or tab may allow the user to select to view the causes supported by purchase.

In one embodiment, the transactions may be recorded in a database, digital ledger of a blockchain system, or other storage system. As a result, the platform may more quickly verify and authenticate transactions for specific goods and services as resulting in payments to the associated goods and services. For example, each transaction may provide an additional verification that there is a verifiable association between purchases of goods or services with payments or other benefits to the associated causes being implemented. Each recorded and verified transaction from distinct transactions or users may build on each other provide an enhanced verification. For example, each transaction is corresponding contribution to charity that is verified may create a verifiable percentage (i.e., 3251 verified cause based contributions out of 3255 total or a 99.87% giving rate).

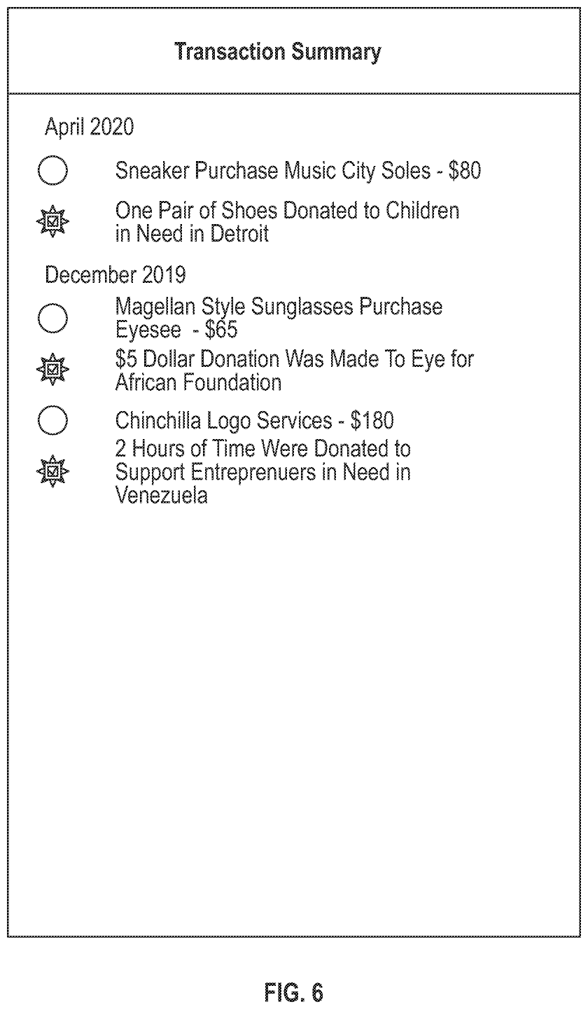

FIG. 6 is a pictorial representation of a transaction summary 600 in accordance with an illustrative embodiment. The transaction summary 600 shows a sample window, email, message, in-application message, or graphical user interface that may be displayed to a user. The transaction summary 600 may present information regarding purchases or transactions performed by a user or group of associated users. In one embodiment, the transaction summary 600 may provide details about the transaction, such as date, time, location, goods/services purchased, seller, taxes, causes supported/actions taken, and levels of cause support (e.g., in-kind donation, monies contributed, hours contributed, etc.).

The communicated or displayed data and information of the transaction summary 600 may be filtered or displayed based on user, date/date range, seller/business, types of goods/services, causes/charities supported, types of cause contributions (e.g., donations, items, hours, etc.), and other applicable transaction or cause-based information and data. For example, the user may be given a summary for specified time periods (e.g., days, weeks, years, all, etc.). The user may also be given information regarding the contributions to specific causes.

The illustrative embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible or non-transitory medium of expression having computer usable program code embodied in the medium. The described embodiments may be provided as a computer program product, or software, that may include a machine-readable medium having stored thereon instructions, which may be used to program a computing system (or other electronic device(s)) to perform a process according to embodiments, whether presently described or not, since every conceivable variation is not enumerated herein. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object-oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (e.g., through the Internet using an Internet Service Provider).

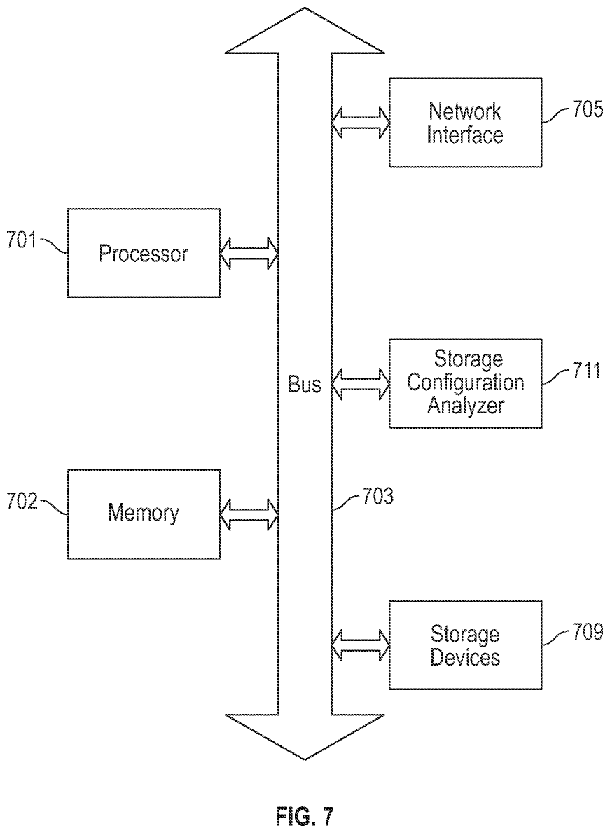

FIG. 7 depicts a computing system 700 in accordance with an illustrative embodiment. For example, the computing system 700 may represent a device, such as one or more of the devices 101 of FIG. 1. The computing system 700 may represent one or more servers function as the sale platform 120 of FIG. 1 (or other stand-alone, networked, or cloud devices). The computing system 700 includes a processor unit 701 (possibly including multiple processors, multiple cores, multiple nodes, and/or implementing multi-threading, etc.). The computing system includes memory 707. The memory 707 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computing system also includes a bus 703 (e.g., PCI, ISA, PCI-Express, HyperTransport®, InfiniBand®, NuBus, etc.), a network interface 705 (e.g., an ATM interface, an Ethernet interface, a Frame Relay interface, SONET interface, wireless interface, etc.), and a storage device(s) 709 (e.g., optical storage, magnetic storage, etc.). The system memory 707 embodies functionality to implement embodiments described above. The system memory 707 may include one or more functionalities that store users, sellers, causes, verification information and data, content, blockchain data, parameters, application, user profiles, and so forth. For example, the system memory 707 may include instructions or hardware for implementing the methods and processes herein described. Code may be implemented in any of the other devices of the computing system 700. Any one of these functionalities may be partially (or entirely) implemented in hardware and/or on the processing unit 701. For example, the functionality may be implemented with an application specific integrated circuit, in logic implemented in the processing unit 701, in a co-processor on a peripheral device or card, etc. Further, realizations may include fewer or additional components not illustrated in FIG. 7 (e.g., video cards, audio cards, additional network interfaces, peripheral devices, etc.). The processor unit 701, the storage device(s) 709, and the network interface 705 are coupled to the bus 703. Although illustrated as being coupled to the bus 703, the memory 707 may be coupled to the processor unit 701.

The illustrative embodiments may provide a resource for consumers to make purchases in a way that supports society, charity, and other causes the consumers agree with. For example, some statistics show that 90% of shoppers are likely to switch to a cause-based product, 88% of consumers want to hear what brands are doing to have an impact, 64% of shoppers want business to integrate social impact directly into their business model, and 88% of consumers would buy a product with a social or environmental benefit.

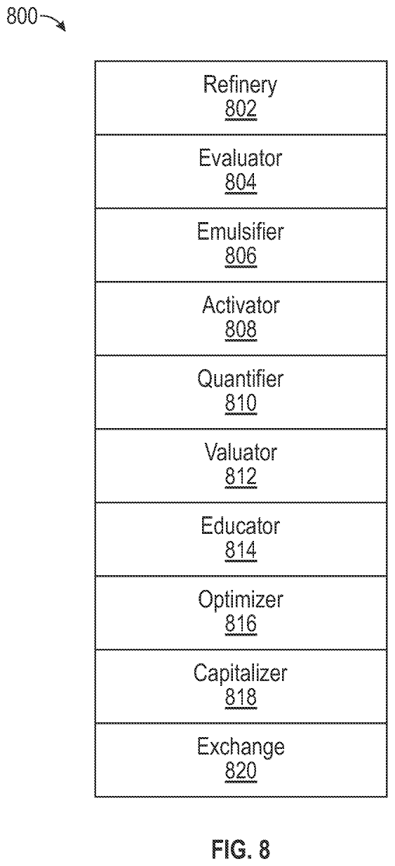

FIG. 8 is a block diagram of a system 800 for supporting minority owned businesses in accordance with an illustrative embodiment. In one embodiment, the system 800 may include a refinery 802, an evaluator 804, an emulsifier 806, an activator 808, a quantifier 810, a valuator 812, an educator 814, an optimizer 816, a capitalizer 818, and/or an exchange 820. The various components of the system 800 may function together or separately. For example, the various components of the system 800 may operate sequentially, concurrently, or simultaneously.

In one embodiment, the system 800 may represent or include an Enterprise Resource Planning (ERP) system that may be implemented as part of the systems and processes of the business. The system 800 may utilize numerous integrated applications to collect, store, manage, and analyze data from various business activities. In one embodiment, the system 800 is cloud-based for easily scaling up the company as needed. The system 800 may communicate with a database management system to track business resources (e.g., cash, raw materials, production capacity, employee hours, goods produced, etc.) and other data across various segments, departments, or components of the business (e.g., manufacturing, purchasing, sales, accounting, etc.). For example, the system 800 may be integrated with and automate significant portions of accounting, bookkeeping, human resources, research and development, engineering, sales management, information technology, marketing, screening platforms (franchises), supply chain/contracts management, and other systems, platforms, devices, and other processes of the business.

The various portions of the system 800 may represent hardware, software, firmware, and/or a combination thereof. For example, the various portions of the system 800 may represent individual systems that are part of the overall system 800 or modules that execute specialized applications, instructions, algorithms, scripts, processes, and functions. In one embodiment, the evaluator 804 may represent a business evaluation system.

The refinery 802 provides logic where data is curated and developed within key business categories relevant to operational and regulatory requirements of the business. The refinery 802 may cultivate information from any number of sources. For example, the refinery 802 may determine relevant information from websites, business databases, social media, governmental filings (e.g., federal, state, regional, local, etc.), profiles, and other applicable information. The refinery 802 may operate sequentially, in-parallel, or utilizing any number of other processes for the business as a whole or segments, divisions, or components of the business.

The evaluator 804 may perform evaluation and valuation of the business. The various criteria, parameters, analysis, algorithms, scripts, and processes herein described may be utilized to evaluate the business profile data utilizing logic, various business profiles may be rated and subsequently ranked as potential investment grade and/or noninvestment grade businesses. The ratings may also include business health metrics designed to measure the health of small businesses by calculating several integrated factors. The evaluator 804 may generate an estimate of performance and valuation based on performance metrics for the company such as a performance quotient that determines the best path for access to capital within the company's available ecosystem and resources. Available funding source profiles may be matched with business profiles that undergo a rigorous filtering and evaluation process for the purpose of funding advance, expansion, day-to-day operations, and other events that require capital infusion. The system 800 may access or utilize local and federal sources of funding through artificial intelligence, business logic, machine learning, and other intelligent processes implemented by the system 800. As a result, the system 800 may perform various acceptance criteria to contribute to the closing of operational, financial, and societal impact gaps through the various company profiles processed by the evaluator 804. The evaluator 804 may perform various types of quotient-based analysis. The evaluator 804 may provide a rating indicating whether the business is ready for evaluation, valuation, and investment.

The evaluator 804 may use quotient rankings and calculations for the purpose of calculating a valuation. Using the quotient system, business profiles may be rated and subsequently ranked as a potential investment grade and non-investment grade companies. An estimation may be derived from quotient performance to determine the best path for access to capital within the businesses' available ecosystem.

The emulsifier 806 provides logic for converting the evaluated business profile data (e.g., processed by the evaluator 804) into one or more numerical ratings that allow a business to address the various segments, departments, or aspects of the business. The emulsifier 806 may utilize artificial intelligence, machine learning, situational analysis, and coaching to generate the one or more ratings.

The activator 808 enables the system 800 to integrate, turn on, or turn off services available through the system 800 as needed or in real time through the performance analysis performed by the system 800. As is well known, the needs and requirements of a business may change significantly by day, week, month, year, or span of years. The illustrative embodiments may allow the ability to turn on and off services and features available through the system 800 utilizing the activator 808. For example, a vendor used for seasonal or poor part-time services may be replaced through a plan driven process utilized by a full-time employee as a company/business passes certain thresholds such as sustainability, stable revenue, proper capitalization, insurance, and other applicable determinations (e.g., quotient driven calculations, estimates, projections, etc.). They activator 808 may be utilized to activate various aspects of the business and illuminate opportunities. For example, the activator 808 may provide an improvement matrix for utilizing the enhanced data sets captured by the system 800.

The quantifier 810 may perform any number of business valuation processes. The quantifier 810 may provide a development process for developing value in the business through evaluation, expansion, and business implementation strategies. For example, the quantifier 810 may track the patents, trademarks, trade secrets, cash, loans, debts, physical and/or virtual assets, and other assets and liabilities of the company to determine how value is held by the company and further developed. The quantifier 810 may value intangible attributes like business locations, position of the business in markets, or unique advantages of the products or services offered by the business.

The quantifier 810 may include an impact calculator that calculates a numerical score after algorithmically extracting data regarding the positive measurable impact, neutral impact, or negative impact a business has on the associated community, region, or state. The positive, neutral, or negative impact calculations may convey detailed character attributes, such as crime level, attrition rate benefits, tenure, recruitment rate, and jobs. The quantifier 810 may also track and separately rate impactful programs of mentorship, all truism, and other forms of renumeration utilizing automated reporting and monitoring.

The valuator 812 provides a baseline of business valuation and analysis of a business's physical and virtual assets. The valuator 812 also underwrites, quantifies, and calculates business investment grade ratings and business health metrics scoring.

The educator 814 provides real-time, E-learning, continuing education, and modular based learning systems and experiences. The educator 814 may include classes and information for various employees, contractors, executives, boards, and others. The educator 814 may be utilized to provide training and education resources that may be more in depth, expansive, and comprehensive than the business may have access to by itself. The illustrative embodiments capture and analyze data regarding the local, regional, and country specific economy. The educator 814 may implement various standardized education programs, skill building programs, associate, undergraduate, and graduate programs, certificate programs, mentoring programs, and other education and knowledge-based programs that are benefit the business (including employees, staff, contractors, executives, and others). The educator 814 may also tailor resources, systems, platforms, and education programs through the various quotients to encourage life-long learning programs, student feeder systems, social emotional training programs, modular learning programs, and trade schools for the business and associated employees, staff, contractors, and educators. The educator 814 may perform real-time aptitude assessment, mentorship, and education assessments to report correlation between data assets and provide accurate information. The educator 814 encourages and tracks career advancements opportunities and failures for the business. Any number of degrees, accreditations, certificates, and other programs are both tracked and adjusted as needed to achieve desired outcomes that maximize opportunities for the business and associated human assets. Businesses may increase or be given additional credit, standing, rankings, and quotients for their educational, mentorship, and protegee programs. Various models implemented by the educator 814 increase the ability to enhance skill sets, map skill sets, explore competencies, and identify strengths and deficiencies. Goal gaps may potentially damage a company's prospects for financing, investment, and so forth.

The optimizer 816 is an optimizing system based on statistics, metrics, data sets, and processes available to the entire system 800. The optimizer 816 may retrieve information and data from any number of internal devices and processes as well as externally available sources.

The capitalizer 818 is a module for matching borrowers (i.e., businesses) with lenders, investors, angels, crowdfunding, and other capital sources, such as grants, and federal, regional, state, community, and local funding sources. The capital out the business as well as the potential lender, investor, or other party providing capital to specify criteria, parameters, or other factors that are utilized for matching. As a result, all of the parties may be satisfied with the applicable matches and any potential loans, investments, capital infusions, or so forth. The capitalizer 818 may match available funding source profiles with business profiles that undergo a rigorous filtering process to achieve successful funding agreements, events, and other capital infusions. The illustrative embodiments contribute to the closing of operation, financial, and social impact gaps from company profiles through quotient analysis to provide financial and other resources and improve criterion.

The exchange 820 is in exchange for small business owners as well as investors and traders of stocks and small business. The exchange 820 may be publicly or privately available. In one embodiment, the exchange 820 is available to a network of individuals that have committed to support a specified number of at-risk or minority owned companies. The exchange 820 may provide a platform where shares of businesses available through the system 800 may be underwritten, audited, and approved for public listing and trading. The exchange 820 may facilitate stockbrokers in trading company stocks and other securities specifically for small businesses only as designated by the United States small business administration. A stock of one of the businesses may only be bought, sold, or involved in other transactions only if listed on the exchange 820. The exchange 820 provides a digital meeting place for transactions involving the exchange 820 approved businesses that support the causes herein described.

The various portions of the system 800 may be branded so that other minority owned businesses may see the success of their peers and participate in the various platforms, systems, and processes herein described.

The illustrative embodiments address businesses that have been identified as non-engaged, non-performing, and unsuccessful companies characterized by success metrics. Previous failures of the business may be addressed to create sustainable assets, strategies, operations, and movement utilizing artificial intelligence, cognitive intelligence, machine learning, mass automation, quantum computing, server process, arrays, and other data systems.

The system 800 may enable gamification of the various components and processes. For example, gamification may be utilized to perform statistical comparison of standard norms and the related performance metrics alongside a display of all-time historical and current business leaderboards. Through incentive programs and other data feeds, the system 800 may derive real-time data, validate the date, normalize the data, secure the data, and perform display functions (e.g., hall of fame, leaderboard, records, economic impact, tax impact, etc.). Various other studies and reports may perform statistical byproducts of quotient management functions. Gamification may be utilized to connect, share, and promote activity from users providing benchmarks and milestones that may be utilized to allow companies to understand where they stand as compared to similar businesses and their peers. The gamification may be completed in tandem with the system 800 contemplating quotient calculations to guide and inform through data systems.

The system 800 may be licensed, white labeled, duplicated, or utilized by other parties, states, cities, or communities. Quotient driven calculations may develop a process of identifying licensing opportunities and system.

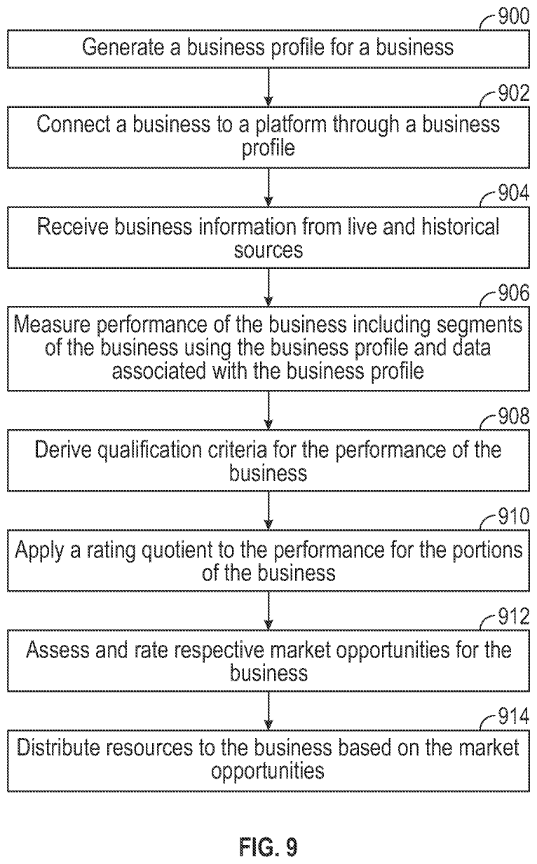

FIG. 9 is a flowchart of a process for supporting minority owned businesses in accordance with an illustrative embodiment. The illustrative embodiments provide a business quotient and rating process enabled through an array of networked appliances that provide for the automated, sustainable, scalable, and implementable capitalization of minority owned small businesses. The process may be implemented by a platform or system as described in FIG. 1, 2, or 8. The process of FIG. 9 may begin by connecting a business to a network through a business profile (step 902). The information may be received or gathered through artificial intelligence, machine learning, blockchain or other technologies.

Next, the system receives business information from live and historical sources (step 904). The system may aggregate and assemble business information from various sources to generate the business profile and receive the business data. The system may bifurcate and measure the performance of various components, segments, or other portions of the business.

Next, the system measures performance of portions of the business including segments of the business using the business profile and data associated with the business (step 906). The performance of different divisions, products/service segments, and other different portions of the business. In one embodiment, investment and commercial banking systems used for the management of retail banking, credit card processing, small business lending, business loan lending, and merchant services for small businesses may be utilized to measure performance and other metrics. Data may be derived from these banking systems. In one embodiment, the businesses provide access to onboard the data and information (e.g., regulatory data, tax data, credit checks Dun & Bradstreet assessments, BSA/AML processes, financial documentation/disclosures/filings, lending evaluations, etc.) through accounts, applications, or other processes. For example, lending evaluations that determine loan eligibility, underwriting determinations, and other factors may be utilized to evaluate the business including strengths and weaknesses, provide deeper insights, and provide a more complete understanding of the business.

Next, the system derives qualification criteria for the performance of the business (step 908). The criteria establish how the performance of the business is mathematically or algorithmically processed, rated (e.g., 1-10, 0-100%, etc.), quantified, and/or evaluated. Through prioritization and regression analysis, the system provides for estimates and time commitments in the areas of strategic planning, regulatory, taxation, and other industry specific concerns. Data analysis may be performed to prioritize, refine, and filter data into achievable goals with defined and outlined steps to obtain the goal in a progressing manner. The criteria of step 908 may establish how information from banking systems is systematically analyzed and processed. For example, the data may be weighted and customized for analysis in the context of industry, geographic region, and cost.

Next, the system applies a rating quotient to the performing for the portions of the business (step 910). The system develops and applies a rating quotient production system derived from a qualification criterion sourced from public and private networks. The system may rate the overall performance of the business as well as the segmented or different components of the business to provide more useful information. The system provides a quotient to the performance within business criterion of qualitative and quantitative performance indicators allowing for cognitive support and automated protections for business operations that provide data inputs and measurement data points. The system eliminated emotional, biased, non-actionable, and wishful thinking that may occur based on user interaction and decision making. Significant benefits are realized by utilizing the systematic intelligence of the data in real-time. As previously noted, weighted values may be applied to the performance information and data.

Next, the system assesses and rates respective market opportunities for the business (step 912). The market opportunities may represent the needs, requirements, opportunities, or other aspects of the business. For example, the market opportunities may allow the business to grow, develop, expand, become more profitable, and otherwise improve. Opportunities for investment, grants, education, improvements, strategy changes, or other opportunities may be presented to the business as part of step 912.

Next, the system distributes resources to the business based on the market opportunities (step 914). Any number of resources may be automatically or selectively distributed to the business. For example, the business may be presented with options for loans, grants, debt, equity, education, training, personnel, support services, system, device, or process upgrades, or so forth. The various business profiles and end-to-end analytics may be leveraged to report information and obtain needed resources including capital. Competition to provide capital may be provided directly or indirectly by country, state, region, locale, or community. The system may provide resources from creation, stabilization, sustainability, scaling, and/or growth. The system may provide various forms of debt financing with investor equity opportunities to finance businesses and deals. Additionally, sources of funding may be presented based on the capital structure of the business may be determined.

In one embodiment, a dashboard may display business information, profiles, criteria, ratings quotients, performance information, market opportunities, and resources for review by the business and various other parties. The dashboard may display the general health of the company as determined through comprehensive analysis. The dashboard may present the information utilizing a wireless or computing device or through a heads-up display, augmented reality systems, virtual reality systems, projection systems, hologram systems, 3D/4D systems, or so forth. As a result, quotient information, data, and calculations may be provided in real-time, on-the-fly, periodically, or on-demand as the situation may require. The quotient may provide data informing any number of business decisions and provides for data point analysis from end-to-end data points within business operations.

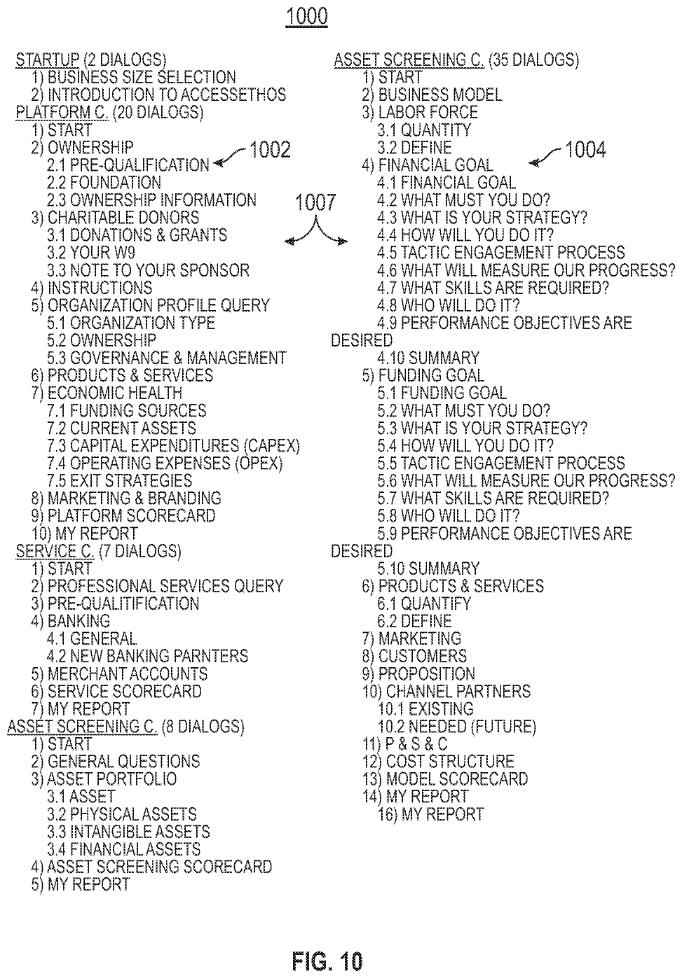

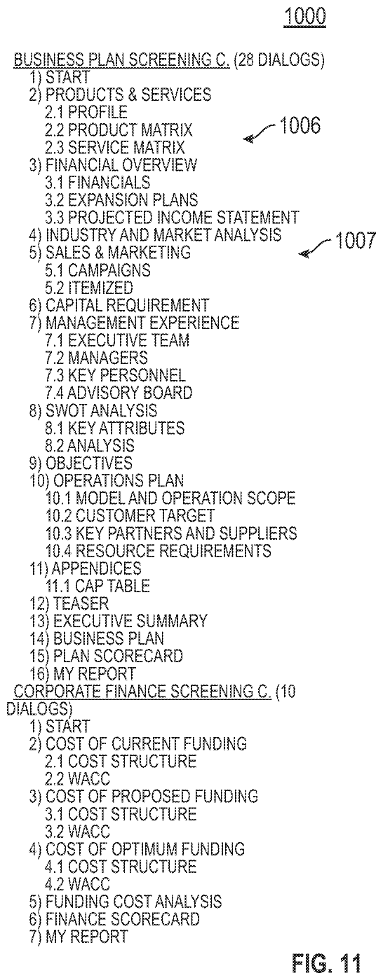

FIGS. 10-11 are pictorial representations of a model 1000 of a system for supporting businesses in accordance with an illustrative embodiment. The model 1000 may include menus 1002, 1004, and 1006 (jointly menu 1007). The model 1000 may be implemented by a system, such as system 100 of FIG. 1 or sale platform 120 of FIG. 2, or other components, systems, or platforms of those Figures. In one embodiment, the model 1000 may be implemented as an interactive website, mobile application, user interface, virtual reality program, or other communication. Each portion of the model 1000 may have a sub-menu or navigation profile associated with it. The model 1000 may be utilized to help a user move a business through all stages of ideation, development, growth, sales, and so forth. The model 1000 may work across different platforms to facilitate the one or more users that may be utilizing the model 1000 at one time. The information associated with the menu 1007 may be presented visually (e.g., graphically, textually, etc.), audibly, and/or tactilely. The model 1000 may include interactive content to facilitate the finding, preparing, calculating, aggregating, and utilization of various different types of content.

In one embodiment, the menu 1000 may be utilized simultaneously by multiple users from a single team, organization, entity, business, or so forth. In one embodiment, the model 1000 may allow specific portions of the menu 1007 to be delegated via email address, username, nickname, or other identifier. As a result, the information and data that is managed by the model 1000 may be optimized for the user resulting in better outcomes (e.g., business plan development, funding, preparation of pitch decks, investor presentations, etc.).

In one embodiment, the menus may include individual webpages, windows, forms, user interfaces, or so forth that may be viewed in any order. Alternatively, the model 1000 may be configured to walk one or more users through from start to finish to achieve applicable goals and maximize results for the associated business.

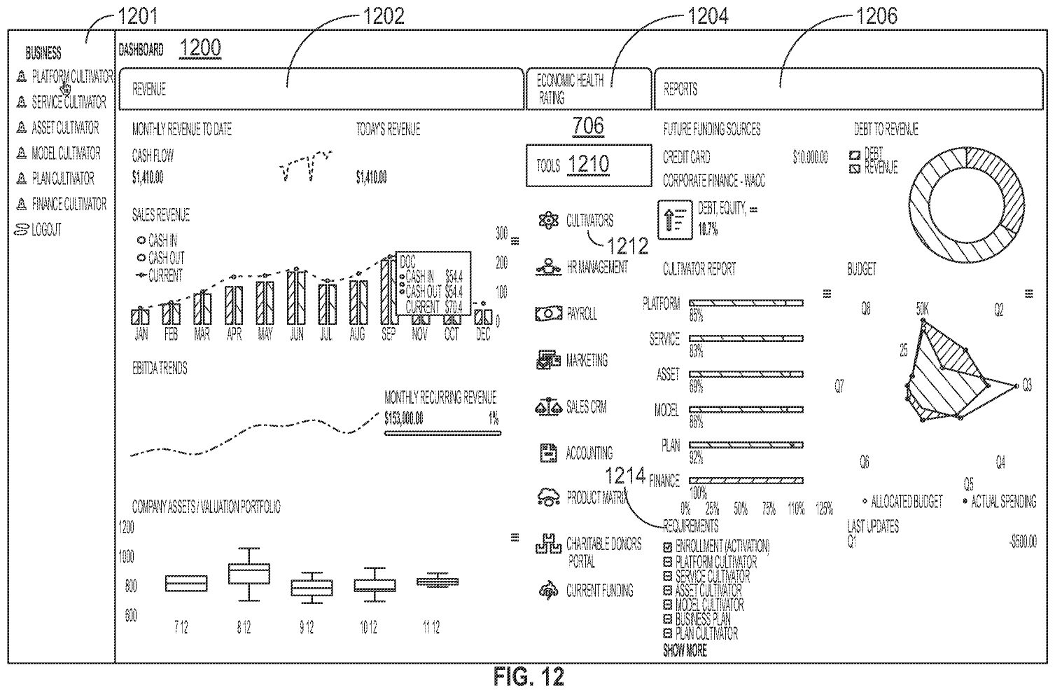

FIG. 12 is a pictorial representation of a dashboard 1200 in accordance with an illustrative embodiment. FIGS. 12-18 and the dashboard 1200 are examples of user interfaces, programs/applications, and the model 1000 of FIGS. 10 and 11. References to a user herein may refer to a business, entity, organization, individual, or individuals that are utilizing the system and method herein described. The dashboard 1200 may be implemented as a program, website, algorithm, and/or user interface configured to display data and information as well as interactive and functional components. In one embodiment, the dashboard 1200 may represent an interactive system that may be implemented utilizing blockchain. The dashboard 1200 may also be implemented in virtual reality or augmented reality to help the user better enter and review information. The dashboard 1200 (and FIGS. 12-18) may utilize any number of buttons, indicators, selections, dials, drop-down menus, databases, tables, and so forth. For example, the user may be able to look up, enter, review, and receive information utilizing the dashboard 1200.

In one embodiment, the dashboard 1200 may utilize optical character recognition (OCR) using a hosting or viewing device, such as a smart phone, tablet, or laptop, to import critical information, such as bank records and employee records. The platform may convert text and images into machine readable language to onboard data to the platform and/or digital ledger of blockchain. As a result, a user may import information, such as financial documents, business plans, and other relevant documentation from existing documents. The dashboard 1200 may allow multiple coordinating users to pull together applicable information as quickly and efficiently as possible. Utilization across network devices may allow the user to compile documents, receipts, tax returns, products, brochures, pictures, video, and other information in the office and in the field.

In another embodiment, the dashboard 1200 may utilize blockchain to document inputs from multiple authorized parties at once. An administrator may specify the individual users that are allowed and/or required to provide specific information (e.g., vice presidents, members, accountants, lawyers, founders, partners, managers, supervisors, etc.).

In one embodiment, the dashboard 1200 may display a menu 1201, revenue 1202 information (e.g., hourly, daily, weekly, monthly, yearly, all, tool, custom, debt to revenue, Earnings Before Interest, Taxes, and Amortization (EBITA), etc.), an economic health rating 1204, reports 1206, and other applicable information. The revenue 1202 may be displayed utilizing any number of data, text, charts, graphics, and other applicable indicators.

The dashboard may also display tools 1210. The tools 1210 may include any number of integrated or externally linked tools for cultivators, Human Resource (HR) management, payroll, marketing, sales Customer Relationship Management (CRM), accounting, product matrix, charitable donors portal, current funding, and others. The various type of cultivators 1212 within the tools 1210 may include a platform cultivator, a service cultivator, an asset cultivator, a model cultivator, a plan cultivator, and a finance cultivator. The dashboard 1200 may provide a tool for navigating the different cultivators which may each have their own dashboard page. In one embodiment, the cultivators 1212 may be performed sequentially as listed to ensure that the user is best enabled to succeed. For example, the cultivators 1212 may be utilized to receive, collect, and aggregate information and data that is required for the user to maximize usage of the system, platform, model, and methods herein described. The cultivators 1212 are similar to advanced wizard modules that operate utilizing one or more algorithms to increase the likelihood that the user/business is successful. In one example, the reports 1208 may display the portion of the different cultivators 1212 that are completed by percentage, points, estimated time remaining, or so forth.

The dashboard 1200 may also display a strategy dashboard for action items, strategy map, tactics, strategies, goals, team, responsibilities, vision, mission, values, priorities, and so forth. The dashboard 1200 may include multiple windows, screens, or interfaces (e.g., HR, employees, business/executive team, center plan, etc.).

The dashboard may display requirements 1214. The requirements 1214 may represent steps, tasks, issues, forms, data, projects, modules, or actions that are required to be completed before the user may move forward within the system. For example, the requirements 1214 may include links to expanded menus of more detailed items that need to be completed.

The dashboard 1200 may utilize colors to provide indicators, green indicates something is complete, orange requires additional information, yellow is less than ideal, red is incomplete or has a problem, grey is not started, and blue is exceeding expectations. The home page or main dashboard 1200 may be accessed utilizing a main logo or button at any time.

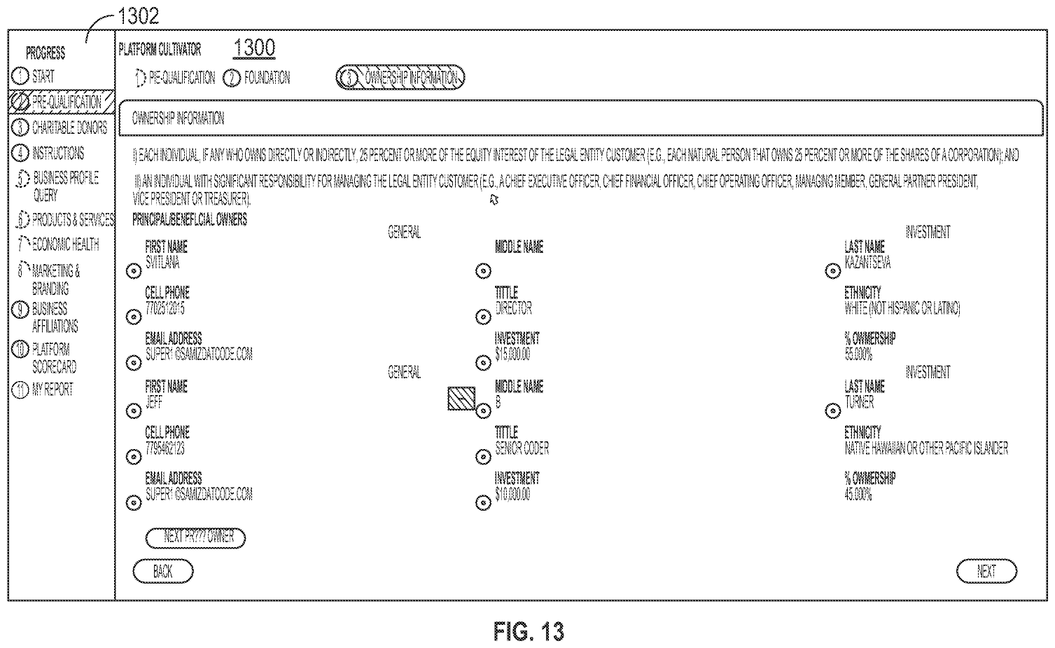

FIG. 13 is a pictorial representation of a platform cultivator 1300 in accordance with an illustrative embodiment. The platform cultivator 1300 may include a menu 1302 for navigating different portions of the selections, graphics, details, and information. In one embodiment, the menu 1302 may include information for pre-qualification, charitable donors, instructions, business profile query, products, and services, economic health, marketing and branding, business affiliates, platform scorecard, and a report.

In one embodiment, the pre-qualifications from the menu 1302 may be utilized to determine whether the user is doing business with the government, what industry or category the user aligns with, what is the business model, is the user a veteran owned business, is the user a woman owned business. The foundation information of the pre-qualifications may allow a user to indicate the name of the business, whether the business in incorporated (or assistance is needed), and contact information/registered agent. The ownership information of the pre-qualifications may list the principle/beneficial owners of the business, key executives (e.g., managing member, chief executive officer, chief financial officer, chief operating officer, managers, general partner, vice president, treasurer, etc.) along with associated contact information. The ownership information may specify percentages, types of ownership/shares, title, ethnicity, investment (e.g., cash, contributions, advisory, assets, etc.), email address, phone number, date acquired/vested, investment round, and so forth.

The platform cultivator 1300 and the menu 1302 may also allow the user to specify whether charitable donations or grants have been received as part of charitable donations. The user may also specify their interest in grants or charitable donations, provide a W9 form, or allow the user a form to thank donors or sponsors. In the same way, the platform cultivator 1300 may allow the user to review information associated with their products and services, economic health, marketing and branding, and business affiliations. All of this information and data may be utilized to create a scorecard associated with the platform cultivator 1300.

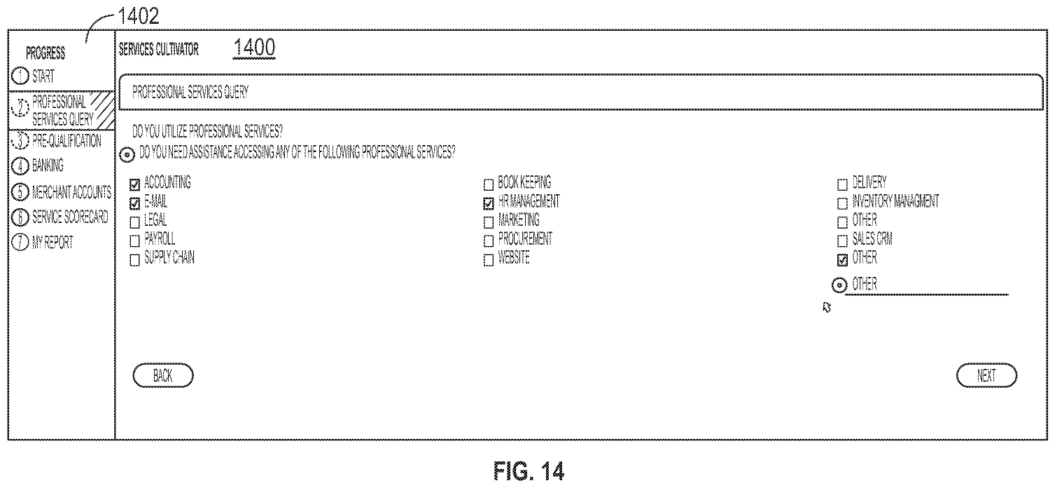

FIG. 14 is a pictorial representation of a services cultivator 1400 in accordance with an illustrative embodiment. The services cultivator 1400 and an associated menu 1402 may be utilized to determine additional information associated with the user. The menu 1402 may include a professional services query, pre-qualification, banking, merchant accounts, and services scorecard. In one embodiment, the services cultivator 1400 may help the user determine whether services, such as accounting, email, legal, payroll, supply chain, bookkeeping, HR management, marketing procurement, website, delivery inventory management, information technology (IT)/cloud networking, sales CRM, or other services are needed. The services cultivator 1400 may also help match the user with vetted, cost effective, or highly rated service providers to ensure that the user is well taken care of by outside service providers.

The pre-qualifications of the menu 1402 may be utilized to determine what the user's business does, whether they have tax returns or banks statements for three years, how much funding the user is looking for, how funds will be utilized, when funds are needed, what are interest rate expectations, is there any existing business loans for the user, and what is the annual revenue.

The services cultivator 1400 may determine who the user banks with, types of accounts, number of accounts, average monthly balances, and other applicable information. The services cultivator 1400 may also determine details and information associated with merchant accounts and services, such as credit card processing, payment processing, e-commerce, accounting software, and other software.

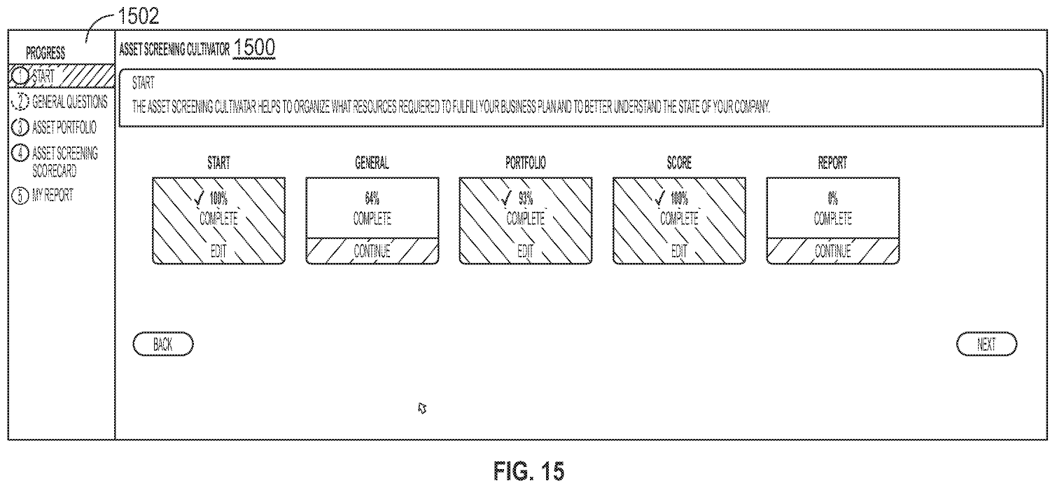

FIG. 15 is a pictorial representation of an asset screening cultivator in accordance with an illustrative embodiment. The asset screening cultivator 1500 may be utilized to organize resources required to fulfill a business plan for a user. The asset screening cultivator 1500 may include a menu 1502 including general questions, asset portfolio, asset screening scorecard, and individual report.

In one example, the general questions may include yes, no, multiple choice, or open ended questions for the user to answer, such as would you like to receive asset offerings that align with your asset acquisition desires, are you interested in owning a franchise (e.g., fast food, travel, retail, etc.), and you interested in owning commercial and/or residential real-estate assets, are you interested in owning or licensing technology assets, what other major business assets do you require, are you interested in acquiring other types of assets not listed?

The asset portfolio of the menu 1502 may include assets owned by the user, such as physical, intangible, and financial assets including digital assets, intellectual property (e.g., patent, trademark, copyright, trade names, trade secrets, etc.), software, logistical data, licensed, proprietary, etc.). The assets may list the value/estimated value, original cost, sale price, or other applicable information.

The menu may also include an asset screening scorecard based on the assets owned by the user, being sought out, or otherwise tracked by the user.

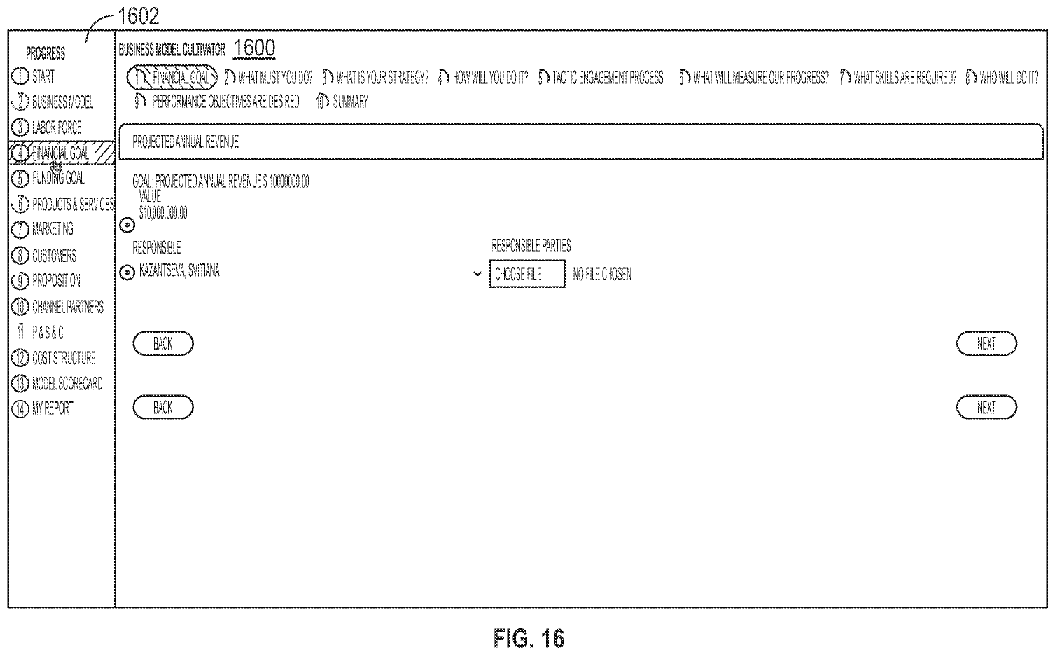

FIG. 16 is a pictorial representation of a business model cultivator 1600 in accordance with an illustrative embodiment. In one embodiment, the business model cultivator 1600 may include a menu 1602 for navigating a business model, labor force, financial goal, funding goal, products & services, marketing, customers, proposition, channel partners, partners, suppliers, and contractors (P&S&C), cost structure, a model scorecard, and a report.

The business model cultivator 1600 may be utilized to receive and develop information regarding the user's business model. A defined business model may help the user to be more successful and efficient. For example, the user may better plan for needs of the company. The user may utilize free form text and drop-down menus to select applicable information. The user may provide information regarding the quantity and definition for their labor force including number of employees or contractors, employee information, delivery services, 3^{rd} party services, benefits provided, and so forth. The employee information may include name, title, employment type, commission type, hire date, email, past commission earned, status, annual salary, location, EEO identification, and so forth.

The business model cultivator 1600 may be utilized to schedule strategic information. The menu 1602 may allow a user to specify information regarding financial goals including what must be done, projected revenue, strategy, actions items to achieve the goal, tactic engagement process, initiatives, progress measurements, required skills, assigned individuals, goal metrics/measurements, strategy map, performance objectives, and a summary. The business model cultivator 1600 may be utilized to specify products and services information, such as specific products (e.g., codes, names, etc.), price, profit, average units should, gross revenue, availability, rate, and so forth. Marketing information may include current geographic market areas, how new customers are reached (e.g., internet, retail location, third party vendors, television, mobile applications, billboards, social media, radio, etc.), slogan, marketing colors, marketing dollars, digital marketing strategy, revenue model type, and so forth.

Customer information may include a description of the user's customers, customer behavior, messaging that aligns with the customer behavior, how does your customer engage with your business, customer database acquisitions, prospective clients, prospective clients, or CRM for maintaining leads and potential sales opportunities. The proposition information may include the user's unique features (e.g., products, passion for communities, reliable economic systems, etc.). The channel partners information may specify whether the user has channel partners, service type (e.g., value added reseller, managed service provider, consultant, system integrator, original equipment manufacturer, independent software vendor, distributor, agency, etc.), website, and so forth. The P&S&C may specify the name, type, service provided, contract issuer name, contract file, start date, contract term, end date, and contract value. The cost structure information may include capital expenditures (e.g., property improvements, software and intellectual property, digital development, NFTs or customer data, vehicles, real estate, heavy equipment, furniture, technical, etc.), and monthly liabilities (asset or property taxes, rent or property maintenance, utilities, insurance, travel, office supplies, marketing and advertising, payroll, payroll taxes, IT & software maintenance, depreciation & amortization, professional services, legal, etc.).

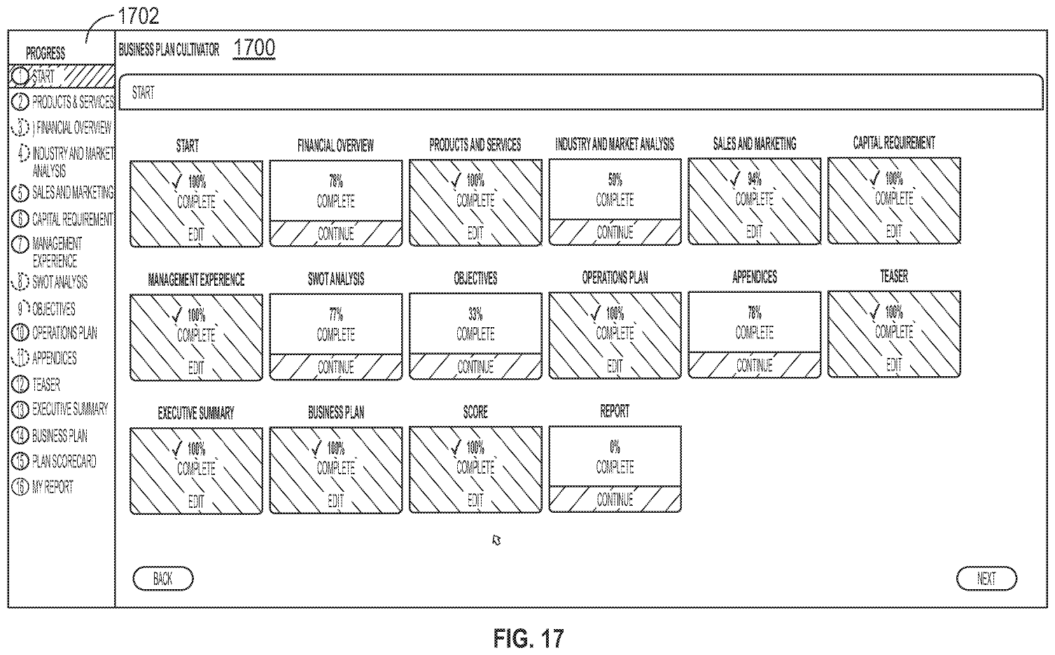

FIG. 17 is a pictorial representation of a business plan cultivator 1700 in accordance with an illustrative embodiment. The business plan cultivator may include a menu 1702 for determining products & services, a financial overview, industry and market analysis, sales and marketing, capital requirements, management experience, SWOT analysis, objectives, an operations plan, appendices, a teaser, an executive summary, a business plan, and a plan scorecard.

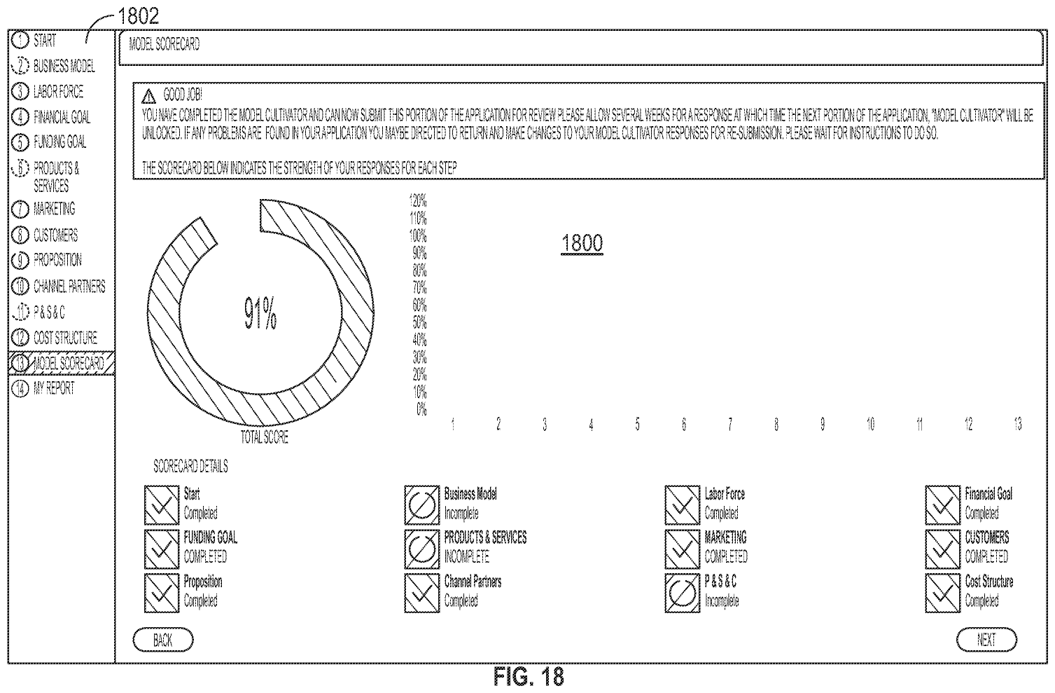

FIG. 18 is a pictorial representation of a model scorecard 1800 in accordance with an illustrative embodiment. The model scorecard 1800 may show percentages of the menu 1802 that is completed (see FIG. 16). The model scorecard 1800 may show percentages completed. Any number of graphics may interactively provide information for the user to enter, receive, and update information that is tracked utilizing the illustrative systems and methods.

The illustrative embodiments may facilitate legal immigration and temporary green card workers. For example, data profiling of migratory workforces may be performed to accommodate the compliance with legal, regulator, and reporting communications. The facilitation and management of profiles of use of the quotient calculations through the process may provide guidance for data reporting and analysis related to immigration and the associated paperwork/filing documents, work status, reporting information, and other data and information associated with legal immigration and asylum seekers.

The features, steps, and components of the illustrative embodiments may be combined in any number of ways and are not limited specifically to those described. In particular, the illustrative embodiments contemplate numerous variations in the smart devices and communications described. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of embodiments, processes or methods of the invention. It is understood that any other modifications, substitutions, and/or additions may be made, which are within the intended spirit and scope of the disclosure. For the foregoing, it can be seen that the disclosure accomplishes at least all of the intended objectives.

The previous detailed description is of a small number of embodiments for implementing the invention and is not intended to be limiting in scope. The following claims set forth a number of the embodiments of the invention disclosed with greater particularity.

What is claimed is:

1. A method for supporting small businesses through a platform, comprising:
generating a business profile for a business;
connecting a business profile to a platform;
receiving business information from live and historical sources for the business profile;
measuring performance of segments of the business;
determining qualification criteria for performance of the segments of the business;
rating the performance of the business utilizing the qualification criteria;
determining market opportunities for the business based on performance ratings for the business; and
distributing resources to the business for acceptance in response to the market opportunities.

2. The method of claim 1, further comprising:
registering the business profile with one or more devices of the platform.

3. The method of claim 1, further comprising:
presenting financing options to the business in response to the rating quotient.

4. The method of claim 1, wherein the business information includes business data associated with the business from a plurality of sources.

5. The method of claim 1, wherein the business is a minority owned business or a disadvantaged business.

6. The method of claim 1, wherein the market opportunities include at least education/training, grants, debt, and equity.

7. The method of claim 1, further comprising:
presenting the business information, qualification criteria, market opportunities, and resources through a dashboard.

8. The method of claim 1, further comprising:
gamifying the performance ratings for a plurality of similar businesses including the business.

9. The method of claim 1, further comprising:
listing the business on an exchange for investors to buy and trade stocks of the business.

10. The method of claim 1, further comprising:
presenting suggestions for the business to qualify for capital investment.

11. The method of claim 1, further comprising:
applying for a number of grants on behalf of the business.

12. A system for supporting businesses, comprising:
a plurality of electronic devices executing a data application, the data application is configured to establish a business profile for a business in response to input from one or more users, and receive business information associated with the business;
a platform accessible by the plurality of electronic devices, the platform measures performance of segments of the business, determines qualification criteria for performance of the segments of the business, rates the performance of the business, determines market opportunities for the business based on performance ratings for the business, and distributes resources to the business for acceptance in response to the market opportunities.

13. The system of claim 12, wherein the plurality of electronic devices include servers of one or more financial institutions associated with the business.

14. The system of claim 12, wherein the platform presents business information, qualification criteria, market opportunities, and resources through a dashboard.

15. The system of claim 14, wherein the platform listing the business on an exchange for investors to buy and trade stocks of the business.

16. A platform for supporting small businesses, comprising:
a processor for executing a set of instructions;
a memory for storing the set of instructions, wherein the instructions are executed to:
generating a business profile for a business that is connected to a platform;
receiving business information from live and historical sources for the business profile;
measuring performance of segments of the business;
determining qualification criteria for performance of the segments of the business;
rating the performance of the business utilizing the qualification criteria;
determining market opportunities for the business based on performance ratings for the business; and
distributing resources to the business for acceptance in response to the market opportunities.

17. The platform of claim 16, wherein the set of instructions are further executed to present financing options to the business in response to the rating quotient.

18. The platform of claim 16, wherein the business information includes business data received from a plurality of sources.

19. The platform of claim 16, wherein the set of instructions are further executed to present the business information, qualification criteria, market opportunities, and resources through a dashboard.

20. The platform of claim 16, wherein the set of instructions are further executed to gamify the performance ratings for a plurality of similar businesses including the business.
